(19) United States
(12) Patent Application Publication
(10) Pub. No.: US 2014/0247274 A1
(43) Pub. Date: Sep. 4, 2014

(54) DISPLAY APPARATUS

(71) Applicant: NIHON KOHDEN CORPORATION, Tokyo (JP)

(72) Inventor: Shinya NAGATA, Tokyo (JP)

(73) Assignee: NIHON KOHDEN CORPORATION, Tokyo (JP)

(21) Appl. No.: 14/187,821

(22) Filed: Feb. 24, 2014

(30) Foreign Application Priority Data
Mar. 4, 2013 (JP) 2013-042045

(51) Int. Cl. G06T 11/00

(52) U.S. Cl. CPC G06T 11/001
USPC 345/593

(57) ABSTRACT

A display apparatus includes: a signal receiving section which is configured to receive a biological signal; a displaying section which is configured to display at least one index corresponding to the biological signal; and a display controlling section which is configured to change a color of the index in accordance with the biological signal, the color corresponding to a color in a triage tag.

### CROSS-REFERENCE TO RELATED APPLICATION(S)

This application is based upon and claims the benefit of priority from prior Japanese patent application No. 2013-042045, filed on Mar. 4, 2013, the entire contents of which are incorporated herein by reference.

### BACKGROUND

The presently disclosed subject matter relates to a display apparatus which receives a biological signal, and which displays an index corresponding to the biological signal.

As an apparatus of this kind, there is an apparatus in which a sensor is attached to a part of the body of the subject, and which acquires a biological signal through the sensor (for example, see JP-A-2012-115640). The apparatus displays an index (a numeral, a symbol, or the like) corresponding to the acquired biological signal on a displaying section as a result of measurement of biological information.

In disaster medical care wherein human and material resources are largely limited, in order to obtain a best rescue effect, triage in which many sick and wounded persons are classified based on the severity and the urgency, and the priority of treatment is determined is introduced. In a chaotic situation where triage is necessary, a medical person is requested to promptly determine the priority and the like. Under such a situation, even when an adequate result of measurement of biological information is displayed on a displaying section, there is a possibility that the result may be erroneously recognized.

### SUMMARY

The presently disclosed subject matter may provide a display apparatus which, in disaster medical care or the like, can prevent erroneous recognition of a result of measurement of biological information from occurring, and assist prompt determination.

The display apparatus may comprise: a signal receiving section which is configured to receive a biological signal; a displaying section which is configured to display at least one index corresponding to the biological signal; and a display controlling section which is configured to change a color of the index in accordance with the biological signal, the color corresponding to a color in a triage tag.

In case where a plurality of the index are displayed on the displaying section, the display controlling section may control all the plurality of index to be displayed in a color indicating a highest priority in the triage tag.

The index may indicate at least one of an arterial blood oxygen saturation, a blood oxygen saturation, a carboxyhemoglobin concentration, a pulse rate, a blood refill time, and a blood refill curve.

There may be also provided a non-transitory computer-readable recording medium storing a program for controlling a display apparatus comprising: a signal receiving section which is configured to receive a biological signal; a displaying section which is configured to display at least one index corresponding to the biological signal; and a computer which is connected to the signal receiving section and the displaying section, the program causing the computer to operate as a display controlling section which is configured to change a color of the index in accordance with the biological signal, the color corresponding to a color in a triage tag.

### BRIEF DESCRIPTION OF THE DRAWINGS

FIG. 1 is a functional block diagram showing the configuration of a display apparatus of an embodiment of the presently disclosed subject matter.

FIG. 2 is a view illustrating an example of a process which is performed by a controlling section of the display apparatus.

FIGS. 3A and 3B are views illustrating another example of the process which is performed by the controlling section.

### DETAILED DESCRIPTION OF EXEMPLARY EMBODIMENTS

An embodiment of the presently disclosed subject matter will be described in detail with reference to the accompanying drawings. In the drawings which will be used in the following description, the scale is adequately changed in order to draw components in a recognizable size.

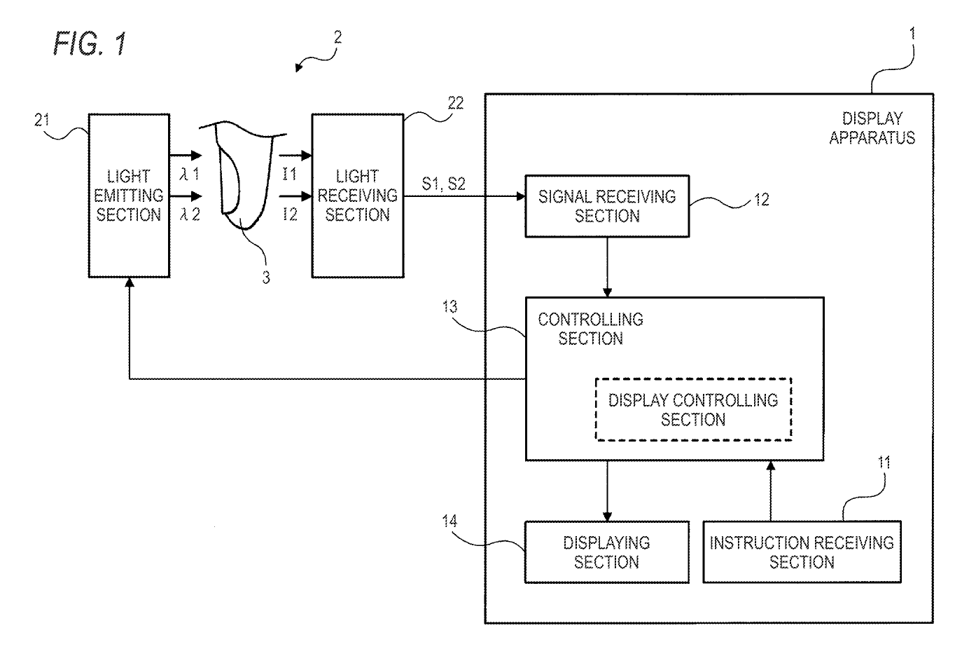

As shown in FIG. 1, a display apparatus 1 of an embodiment of the presently disclosed subject matter is used while a probe 2 which is attached to, for example, the finger 3 of the subject is connected to the display apparatus. The display apparatus 1 includes an instruction receiving section 11, a signal receiving section 12, a controlling section 13, and a displaying section 14. The probe 2 has a related-art two-wavelength type configuration which is to be used in pulse oximetry, and includes a light emitting section 21 and a light receiving section 22.

The instruction receiving section 11 is a man-machine interface which is disposed on the outer surface of the display apparatus 1, and configured so as to be able to receive instructions which are input by the user in order to cause the display apparatus 1 to perform a desired operation.

The controlling section 13 includes: a CPU which performs various calculation processes; a ROM which stores various control programs; a RAM which is used as a working area for storing data and executing the programs; and the like, and performs various controls in the display apparatus 1. The controlling section 13 is communicably connected to the instruction receiving section 11. The instruction receiving section 11 supplies a signal corresponding to the received instructions, to the controlling section 13.

The light emitting section 21 of the probe 2 is communicably connected to the controlling section 13 of the display apparatus 1. The light emitting section 21 can emit a first light beam having a first wavelength λ1, and a second light beam having a second wavelength λ2. In the embodiment, the light emitting section 21 includes a light emitting diode which emits a red light beam of 660 nm that is an example of the first wavelength λ1, and another light emitting diode which emits an infrared light beam of 940 nm that is an example of the second wavelength λ2. In accordance with a control signal supplied from the controlling section 13, each of the light emitting diodes emits the light beam at predetermined timings. The emitted first and second light beams enter the finger 3 of the subject.

The light receiving section 22 of the probe 2 is placed at a position where the first and second light beams which have been passed through the finger 3 can be received. The light receiving section 22 is configured so as to be able to output a first signal S1 corresponding to the intensity I1 of the received first light beam, and a second signal S2 corresponding to the intensity I2 of the received second light beam. In the embodiment, photodiodes are used as devices having such a configuration. The light receiving section 22 is communicably connected to the signal receiving section 12 of the display apparatus 1. The signals S1, S2 (an example of the biological signal) which are output from the light receiving section 22 are supplied to the signal receiving section 12.

The signal receiving section 12 is communicably connected to the controlling section 13. The signal receiving section 12 supplies the received signals S1, S2 to the controlling section 13. The controlling section 13 is configured so as to be able to measure the arterial blood oxygen saturation, pulse rate, and blood refill time of the subject based on the supplied signals S1, S2. The arterial blood oxygen saturation and the pulse rate can be measured by related-art methods, and therefore their detailed description will be omitted.

Hereinafter, a method of measuring the blood refill time based on the signals S1, S2 will be described in detail. Measurement of the blood refill time is a technique which is used in the field of emergency medicine in order to determine necessity/unnecessity of transfusion or the priority in a scene of triage. Specifically, a medical person pressurizes living tissue of the subject, such as a fingertip, and visually checks a change of the color of the skin after the pressurization is released. If the color returns to the original color within two seconds, it is determined that the subject is in a normal condition.

In the case where pulse oximetry is used in measurement of the blood refill time, a light beam of a wavelength which allows the light beam to be absorbed into blood is incident on a fingertip, and the intensity of the light beam which is transmitted therethrough is measured (hereinafter, the intensity is referred to as the transmitted light intensity). Blood is evacuated from the living tissue portion by pressurization, and therefore the transmitted light intensity is increased. When the pressurization is released, the portion is filled with blood, and therefore the transmitted light intensity is decreased. The blood refill time is identified based on the time period which elapses after the release of the pressurization until the transmitted light intensity returns to the original level.

The controlling section 13 is configured so as to acquire the light attenuation A1 of the first light beam based on the first signal S1, and the light attenuation A2 of the second light beam based on the second signal S2. Each of the light attenuations A1, A2 is calculated as a ratio of the amount of light of the first or second signal S1 or S2 received at a certain time (for example, during pressurization of the tissue) to that at another time (for example, before pressurization of the tissue), and indicated by either of the following expressions:

A1=log(I1/Io1) (1)

A2=log(I2/Io2) (2)

where Io1 and Io2 indicate the amounts of received light at the reference time (for example, before pressurization of the tissue), and I1 and I2 indicate the amounts of received light at the measurement. The suffix “1” indicates the first light beam, and the suffix “2” indicates the second light beam.

The controlling section 13 is configured so as to acquire the blood-derived light attenuation based on the light attenuations A1, A2 of the first and second light beams which are acquired as described above. Specifically, the section is configured so as to acquire the blood-derived light attenuation Ab based on the difference of the light attenuation A1 and the light attenuation A2. The principle of the process will be described in detail below.

A change A in light attenuation which is produced when the finger 3 is pressed to change the thickness of the tissue is caused by a change in thickness of blood and that of thickness of tissue other than blood (hereinafter, such tissue is referred to as non-blood tissue). This fact is indicated by the following expressions:

A1=Ab1+At1=E1HbDb+Z1Dt (3)

A2=Ab2+At2=E2HbDb+Z2Dt (4)

where E indicates the absorption coefficient (dl g⁻¹ cm⁻¹), Hb indicates the hemoglobin concentration (g dl⁻¹), Z indicates the light attenuation factor (cm⁻¹) of the non-blood tissue, and D indicates the changed thickness (cm). The suffix “b” indicates blood, the suffix “t” indicates the non-blood tissue, the suffix “1” indicates the first light beam, and the suffix “2” indicates the second light beam.

The wavelength dependency of the non-blood tissue can be neglected. Therefore, it can be deemed that Z1=Z2. When Expression (3) is subtracted from Expression (4), the following expression is obtained:

A2−A1=(E2−E1)HbDb (5).

The right side contains only information of blood. When the difference of the light attenuation A1 and the light attenuation A2 is obtained, therefore, it is possible to acquire the blood-derived light attenuation Ab.

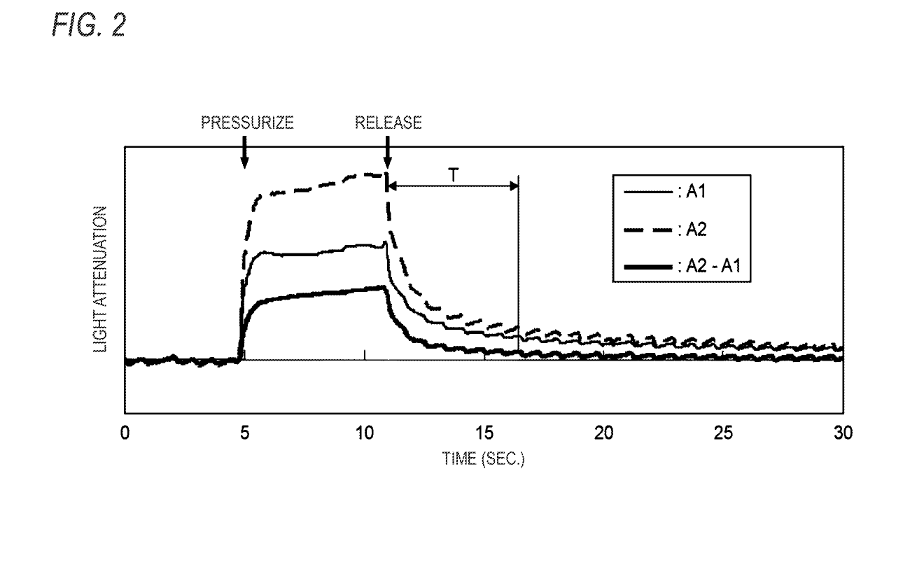

FIG. 2 shows a graph showing temporal changes of the light attenuation A1, the light attenuation A2, and the blood-derived light attenuation Ab (=A2−A1) in the case where the finger 3 is pressed through the probe 2.

It is seen that, even when the pressurization is released, the values of the light attenuations A1, A2 do not return to the levels which are attained before the start of the pressurization, and the deformation of the non-blood tissue exerts influence. It is also seen that, after the release of the pressurization, the difference (A2−A1) of the light attenuations, i.e., the blood-derived light attenuation Ab converges to the level which is attained before the start of the pressurization. Namely, the influence caused by the deformation of the non-blood tissue can be eliminated by a simple calculation process in which the difference of the light attenuations that are obtained by irradiating the tissue with light beams of different wavelengths is calculated.

The controlling section 13 is configured so as to identify the blood refill time for filling the living tissue, based on the temporal change of the blood-derived light attenuation Ab (=A2−A1) which is acquired as described above, and which is associated with pressurization of the finger 3. Specifically, an adequate threshold is set at which it can be determined that the blood-derived light attenuation Ab approaches to some extent the level that is attained before the start of the pressurization. Then, the time period (T in FIG. 2) elapsing from the timing when the pressurization is released, until the blood-derived light attenuation Ab reaches the threshold is identified as the blood refill time. Therefore, the blood refill time can be correctly identified without being affected by the deformation of the non-blood tissue which is caused by a difference in the degree of pressurization.

The displaying section 14 is configured by a display device which is disposed on the outer surface of the display apparatus 1. The displaying section 14 is communicably connected to the controlling section 13. The controlling section 13 supplies signals indicative of the arterial blood oxygen saturation, pulse rate, and blood refill time T which are identified as described above, to the displaying section 14. In accordance with the supplied signals, the displaying section 14 displays indexes (numerals, symbols, and the like) respectively indicating the biological parameters, in an adequate manner. Namely, the displaying section 14 is configured so as to be able to display indexes corresponding to the biological signals supplied to the signal receiving section 12.

The controlling section 13 further supplies a signal indicative of the temporal change of the blood-derived light attenuation Ab which is acquired as described above, to the displaying section 14. The displaying section 14 is configured so as to display a graph (the curve of A2−A1 shown in FIG. 2) showing the temporal change of the blood-derived light attenuation Ab, as a blood refill curve.

When a medical person performs only works of attaching the existing probe 2 which is to be used in pulse oximetry, to the finger 3 of the subject, and pressing the finger 3 through the probe 2, therefore, the medical person is enabled to recognize the blood refill time T which is accurately identified, and the blood refill curve on the displaying section 14.

The controlling section 13 further functions as an example of the display controlling section, and is configured so as to be able to change the colors of the indexes displayed on the displaying section 14. The colors correspond to those in a triage tag.

In triage, categories for determining the order of rescue treatment in disaster medical care are determined. A triage tag is a card having tags of four colors. In the case where a plurality of rescue teams are mobilized, for example, triage tags are used in order to perform communication, sharing of information, and the like among the teams. It is specified that a triage tag in a state where an unnecessary color marker(s) is torn off is attached to the right wrist of a sick or wounded person, and the color of the marker which remains at the edge shows the condition of the sick or wounded person. The color of each marker indicates the condition of a sick or wounded person in the following manner.

Black: Category 0 (death group)
Patients who are dead, or who show no signs of life and have no possibility of rescue

Red: Category I (immediate treatment group)
Patients who are in a life threatening sever condition, and who require immediate treatment

Yellow: Category II (queuing treatment group)
Patients who are not in a life threatening sever condition, and who require early treatment

Green: Category III (suspension group)
Patients who do not require early treatment or transport (including those who are completely unnecessary to be treated)

In the controlling section 13, correspondence relationships between the value ranges of the biological parameters and the colors in a triage tag corresponding to the conditions of the subject indicated by the value ranges are stored in the form of a table. The controlling section 13 which functions as the display controlling section refers the table, and identifies the color in a triage tag corresponding to the values of acquired biological parameters. The signals which are supplied to the displaying section 14 are correlated with information indicating the identified color in a triage tag. The signals corresponding to the blood refill time and the blood refill curve are correlated with the same color information.

The displaying section 14 displays the indexes indicating the measurement values of the biological parameters, in the respective colors which are defined by the controlling section 13. In the case where the arterial blood oxygen saturation is a value corresponding to Category I above, for example, the index indicating the arterial blood oxygen saturation is displayed in red, i.e., the color in a triage tag which corresponds to Category I.

The medical person is enabled to recognize an index indicating the measurement result of at least one of the arterial blood oxygen saturation, the pulse rate, the blood refill time, and the blood refill curve, on the displaying section 14 simply by attaching the probe 2 for pulse oximetry to the finger 3 of the subject, and starting measurement through the instruction receiving section 11. At this time, the index is displayed in the color in a triage tag which corresponds to the condition of the subject. Also in disaster medical care in which a chaotic situation usually occurs, therefore, a result of measurement of biological information can be prevented from being erroneously recognized, and it is possible to assist prompt determination on the condition of the subject.

The foregoing description of the embodiment of the presently disclosed subject matter has been made in order to facilitate understanding of the presently disclosed subject matter, and is not intended to limit the presently disclosed subject matter. It is a matter of course that the presently disclosed subject matter may be changed or improved without departing the spirit thereof, and includes equivalents thereof.

In the displaying section 14 in the embodiment, for each of the biological parameters, the index may be displayed in different colors which respectively correspond to the severity. In this case, a medical person can immediately know which one of the biological parameters is problematic. In the case where the priority of treatment of the subject is to be finally determined, when indexes are displayed respectively in a plurality of colors, however, there is a possibility that the condition may be hardly determined.

In the case where indexes of a plurality of biological parameters are to be displayed on the displaying section 14, therefore, the controlling section 13 which functions as the display controlling section may be configured so as to display all the indexes in the color in a triage tag which indicates the highest priority. Red is the color of the highest priority, and the priority is then lowered in the sequence of yellow, green, and black.

A case will be considered where indexes showing measurement values of the arterial blood oxygen saturation, the pulse rate, and the blood refill time are to be displayed. When the value of the pulse rate corresponds to Category I, for example, all the indexes are displayed in red even when the values of the other biological parameters correspond to Category II.

According to the configuration, a medical person can determine more promptly the condition of the subject. The display colors of the indexes are unified into a color of a higher priority. Therefore, the possibility that insufficient treatment may be performed can be reduced.

The light receiving section 22 is not always required to be placed at a position where the light beams which have been passed through the finger 3 can be received. Alternatively, a configuration may be employed where the light receiving section is placed at a position where light beams which have been reflected from the finger 3 are received, and the light attenuations are acquired based on the reflection intensities of the light beams of different wavelengths.

The living tissue to which the probe 2 is to be attached is not limited to the finger 3. Any kind of living tissue may be selected as the object as far as the desired measurement can be performed. For example, the earlobe may be used as the object.

When a probe for pulse oximetry in which measurement is conducted by using light beams of three or more wavelengths is connected to the display apparatus 1, the degree of oxygenation of whole blood including venous blood, i.e., the blood oxygen saturation, and the carboxyhemoglobin concentration can be measured and displayed in addition to the above-described biological parameters. Hereinafter, the principle of measurement of the blood oxygen saturation will be described. The carboxyhemoglobin concentration can be measured by a related-art method, and therefore its detailed description will be omitted.

The light emitting section of the probe can emit the first light beam having the first wavelength λ1, the second light beam having the second wavelength λ2, and a third light beam having a third wavelength λ3. An example of the first wavelength λ1 is a red light beam of 660 nm, that of the second wavelength λ2 is an infrared light beam of 940 nm, and that of the third wavelength λ3 is an infrared light beam of 810 nm. In accordance with a control signal supplied from the controlling section 13, the light emitting section emits the light beams at predetermined timings. The emitted first, second, and third light beams enter the finger of the subject.

The light receiving section is placed at a position where the first, second, and third light beams which have been passed through the finger can be received. The light receiving section is configured so as to be able to output the first signal S1 corresponding to the intensity I1 of the received first light beam, the second signal S2 corresponding to the intensity I2 of the received second light beam, and a third signal S3 corresponding to the intensity I3 of the received third light beam. The light receiving section is communicably connected to the signal receiving section 12 of the display apparatus 1. The signals S1, S2, S3 which are output from the light receiving section are supplied to the signal receiving section 12. The signal receiving section 12 is communicably connected to the controlling section 13. The signal receiving section 12 supplies the received signals S1, S2, S3 to the controlling section 13.

The controlling section 13 is configured so as to acquire the light attenuation A1 of the first light beam based on the first signal S1, the light attenuation A2 of the second light beam based on the second signal S2, and the light attenuation A3 of the third light beam based on the third signal S3. Each of the light attenuations A1, A2, A3 is calculated as a ratio of the amount of light of the first, second, or third signal S1, S2, or S3 received at a certain time (for example, before pressurization of the living tissue) to that at another time (for example, during pressurization of the living tissue), and indicated by either of the following expressions:

A1=log(I1/Io1) (6)

A2=log(I2/Io2) (7)

A3=log(I3/Io3) (8)

where Io1, Io2, and Io3 indicate the amount of received light at the reference time (for example, before pressurization of the living tissue), and I1, I2, and I3 indicate the amount of received light at the measurement. The suffix “1” indicates the first light beam, the suffix “2” indicates the second light beam, and the suffix “3” indicates the third light beam.

The controlling section 13 is configured so as to acquire the blood-derived light attenuation based on the light attenuations A1, A2 of the first and second light beams acquired by a first calculating section 41A, and the light attenuations A2, A3 of the second and third light beams. Specifically, the section is configured so as to acquire a blood-derived light attenuation Ab21 based on the difference of the light attenuation A1 and the light attenuation A2, and acquire a blood-derived light attenuation Ab23 based on the difference of the light attenuation A2 and the light attenuation A3. The principle of the process will be described in detail below.

A change A in light attenuation which is produced when the finger is pressed to change the thickness of the living tissue is caused by a change in thickness of blood and that of thickness of the non-blood tissue. This fact is indicated by the following expressions:

A1=Ab1+At1=E1HbDb+Z1Dt (9)

A2=Ab2+At2=E2HbDb+Z2Dt (10)

A3=Ab3+At3=E3HbDb+Z3Dt (11)

where E indicates the absorption coefficient (dl g⁻¹cm⁻¹), Hb indicates the hemoglobin concentration (g dl⁻¹), Z indicates the light attenuation factor (cm⁻¹) of the non-blood tissue, and D indicates the thickness (cm). The suffix “b” indicates blood, the suffix “t” indicates the non-blood tissue, the suffix “1” indicates the first light beam, the suffix “2” indicates the second light beam, and the suffix “3” indicates the third light beam.

The wavelength dependency of the non-blood tissue can be neglected. Therefore, it can be deemed that Z1=Z2=Z3. When Expression (9) is subtracted from Expression (10), and Expression (11) is subtracted from Expression (10), the following expressions are obtained:

Ab21=A2−A1=(E2−E1)HbDb (12)

Ab23=A2−A3=(E2−E3)HbDb (13).

The right sides contain only information of blood. When the difference of the light attenuation A1 and the light attenuation A2, and that of the light attenuation A2 and the light attenuation A3 are obtained, therefore, it is possible to acquire the blood-derived light attenuations Ab21, Ab23.

Next, Expression (12) is divided by Expression (13), the terms of Hb and Db are deleted, and the following expression is obtained:

Ab21/Ab23=(A2−A1)/(A2−A3)=(E2−E1)/(E2−E3) (14).

In Expression (14), (E2−E1) and (E2−E3) are functions of the blood oxygen saturation S. The absorption coefficients E1, E2, E3 are expressed by the following expressions, respectively:

E1=Eo1S+Er1(1−S) (15)

E2=Eo2S+Er2(1−S) (16)

E3=Eo3S+Er3(1−S) (17)

where Eo indicates the absorption coefficient of oxyhemoglobin, Er indicates the absorption coefficient of reduced hemoglobin, and S indicates the blood oxygen saturation. Similarly with the above, the suffix “1” indicates the first light beam, the suffix “2” indicates the second light beam, and the suffix “3” indicates the third light beam.

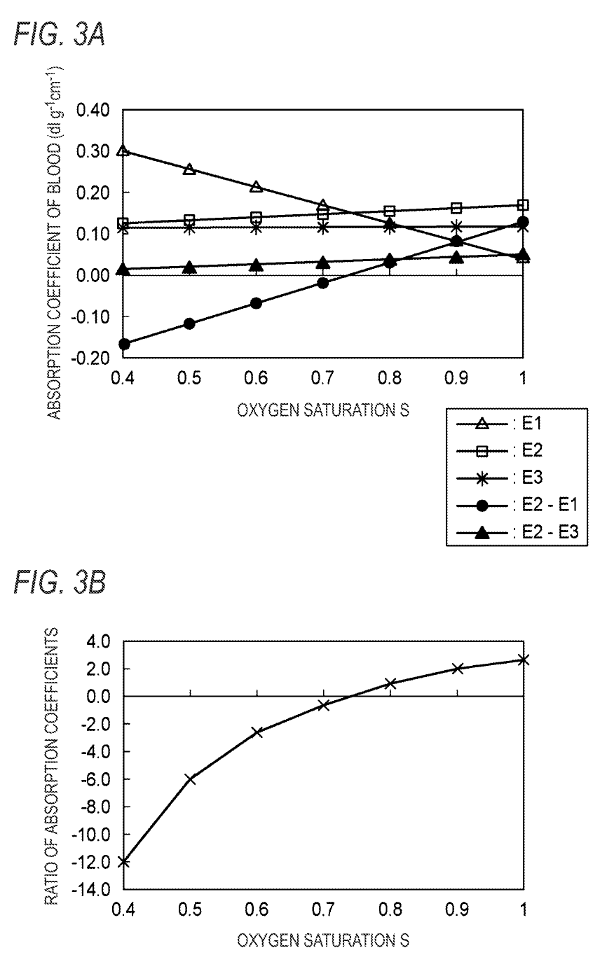

FIG. 3A shows relationships between the absorption coefficients E1, E2, E3, (E2−E1), and (E2−E3), and the blood oxygen saturation S. As shown in FIG. 3B, therefore, also the ratio of (E2−E1) and (E2−E3) is a function of the blood oxygen saturation S.

From the above, it is seen that, when the blood-derived light attenuations Ab21, Ab23 are measured by using at least three light beams having different wavelengths, the blood oxygen saturation S can be quantitatively identified through Expressions (14) to (17). The controlling section 13 is configured so as to identify the blood oxygen saturation S based on the principle.

The controlling section 13 supplies the signal indicative of the identified blood oxygen saturation S, to the displaying section 14. In accordance with the supplied signal, the displaying section 14 displays an index (a numeral, a symbol, or the like) indicating the blood oxygen saturation S, in an adequate manner. Therefore, the identified blood oxygen saturation S is allowed to be displayed on the displaying section 14, simply by attaching the probe for pulse oximetry in which measurement is conducted by using light beams of three or more wavelengths, to the finger of the subject. Similarly with the above-described embodiment, the index indicating the blood oxygen saturation is displayed in the color in a triage tag which corresponds to the condition of the subject.

The function of the above-described display controlling section can be realized by the operation of hardware such as circuit devices, that of software such as programs the computer-readable recording medium or stored in the controlling section 13 which is an example of the computer, or a combination of these operations.

According to an aspect of the presently disclosed subject matter, a medical person can recognize the index corresponding to the biological signal of the subject, on the displaying section. At this time, the index is displayed in a color in a triage tag corresponding to the condition of the subject. Also in disaster medical care in which a chaotic situation usually occurs, therefore, a result of measurement of biological information can be prevented from being erroneously recognized, and it is possible to assist prompt determination on the condition of the subject.

In case where a plurality of the index are displayed on the displaying section, the display controlling section may control all the plurality of index to be displayed in a color indicating a highest priority in the triage tag. In this case, a medical person can determine more promptly the condition of the subject. The display colors of the plurality of indexes are unified into a color of a higher priority. Therefore, it is possible to reduce the possibility that insufficient treatment may be performed.

The index may indicate at least one of an arterial blood oxygen saturation, a blood oxygen saturation, a carboxyhemoglobin concentration, a pulse rate, a blood refill time, and a blood refill curve. In this case, in order to recognize, on the displaying section, an index indicating a result of measurement of at least one of the biological parameters, a medical person is requested only to attach a probe for pulse oximetry to the subject.

What is claimed is:

1. A display apparatus comprising:
a signal receiving section which is configured to receive a biological signal;
a displaying section which is configured to display at least one index corresponding to the biological signal; and
a display controlling section which is configured to change a color of the index in accordance with the biological signal, the color corresponding to a color in a triage tag.

2. The display apparatus according to claim 1, wherein, in case where a plurality of the index are displayed on the displaying section, the display controlling section controls all the plurality of index to be displayed in a color indicating a highest priority in the triage tag.

3. The display apparatus according to claim 1, wherein the index indicates at least one of an arterial blood oxygen saturation, a blood oxygen saturation, a carboxyhemoglobin concentration, a pulse rate, a blood refill time, and a blood refill curve.

4. A non-transitory computer-readable recording medium storing a program for controlling a display apparatus comprising: a signal receiving section which is configured to receive a biological signal; a displaying section which is configured to display at least one index corresponding to the biological signal; and a computer which is connected to the signal receiving section and the displaying section, the program causing the computer to operate as a display controlling section which is configured to change a color of the index in accordance with the biological signal, the color corresponding to a color in a triage tag.
